(19) United States
(12) Patent Application Publication
(10) Pub. No.: US 2008/0034931 A1
(43) Pub. Date: Feb. 14, 2008

(54) LASER GUIDE

(76) Inventor: Derek J. Nash, Huntersville, NC (US)

Correspondence Address: Dennis J. Williamson;Moore & Van Allen PLLC, PO Box 13706, 430 Davis Drive, Suite 500, Research Triangle Park, NC, 27709, US

(21) Appl. No.: 11/463,606

(22) Filed: Aug. 10, 2006

(51) Int. Cl. B23D 45/04

(52) U.S. Cl. 83/13; 83/490; 83/520

(57) ABSTRACT

The laser guide comprises a housing that houses the laser, power source and an on/off switch. A centrally located aperture is formed in the housing and is dimensioned to receive a first size arbor. An annular insert is provided that fits into the aperture to reduce the aperture size from the first size to a second smaller size. The laser guide is provided with an integrated flange to support the blade. The flange spreads the load on the blade caused by the tightening of the retaining member over a larger area to prevent deformation of the blade.

The invention relates generally to laser guides for power saws and more particularly to a laser guide that can be adapted to different size arbors and that is suitable for use as a cutting wheel or saw blade flange.

### BACKGROUND OF THE INVENTION

Power saws such as chop saws, miter saws and radial saws are known that consist of a saw blade or cutting wheel that is mounted on an arbor and rotated at high speeds. The arbor is typically mounted on a movable support such the saw blade or cutting wheel can be brought into engagement with a work piece. One problem with such saws is the difficulty in aligning the saw blade or cutting wheel with the work piece such that the cutting wheel or blade cuts the work piece in the desired location.

To overcome this problem, laser guides have been developed that produce a line of light on the work piece that is used to align the work piece with the blade or cutting wheel. The known laser guides comprise an annular housing that is mounted on the saw arbor immediately adjacent the saw blade or cutting wheel. The housing contains a laser, power source such as batteries and an on/off switch such that the laser guide produces a beam of light. The laser guide rotates with the saw blade or cutting wheel at high speed such that the beam of light produces a visual line of light on the work piece. Because the light beam is produced immediately adjacent to the saw blade or cutting wheel it can be used to align the work piece relative to the blade or wheel. Examples of such laser guides are illustrated in U.S. Pat. No. 5,862,727 issued on Jan. 26, 1999 to Kelly and U.S. Pat. No. 6,035,757 issued on Mar. 14, 2000 to Caluori et al.

One problem with the known laser guides is that the hole for receiving the saw arbor is designed to accommodate only a one inch diameter arbor. Some saws, such as chop saws, have a ⅝ inch diameter arbor. Other arbor sizes may also be found. As a result, the known laser guides are limited in their use.

To mount the blade or cutting wheel on the arbor the blade or wheel is clamped under pressure by a retaining member such as a bolt. Saws that use large saw blades or saws such as chop saws that use less stiff cutting wheels such as fiberglass/resin composite cutting wheels typically use large flanges mounted on the arbor that abut opposite sides of the blade or cutting wheel and function to spread the clamping force over a relatively wide area on the blade or wheel with each flange opposing the force generated by the other flange. Without these opposed, relatively large flanges the saw blade or wheel will deform when the clamping force is applied.

Existing laser guides are smaller in diameter than the flanges and cannot be used with such saw blades and cutting wheels. If the laser guide is secured on the arbor in addition to the flanges, the flanges create too much distance between the laser guide and the blade or wheel such that the laser line is no longer representative of the position of the blade or wheel. Moreover, some saws may not be able to accommodate the added width of the laser guide. If the laser guides are used in place of the flange such that the laser guide abuts the blade or wheel, the forces applied to one side of the blade or cutting wheel by the inner flange are not equally opposed by the smaller laser guide on the opposite side of the blade or wheel. As a result, the blade or cutting wheel will be deformed thereby adversely affecting performance and creating a potentially dangerous situation.

Thus, an improved laser guide suitable for use with saw blades and cutting wheels on a variety of rotary power saws is desired.

### SUMMARY OF THE INVENTION

The laser guide of the invention comprises an annular housing that houses the laser, power source such as batteries and an on/off switch. A centrally located aperture is formed in the housing and is dimensioned to receive a first size arbor. An annular insert is provided that fits into the aperture to reduce the aperture size from the first size to a second smaller size. The laser guide is provided with an integrated flange to support the blade or cutting wheel in the same manner as the flanges currently used on certain power saws. The flange covers approximately the same portion of the blade or cutting wheel as the existing flanges to equalize the load applied to opposite sides of the blade or cutting wheel to thereby prevent deformation of the blade. The integrated flange may be provided with a tapered profile to simulate the look of a typical flange and to reduce the weight of the device.

### BRIEF DESCRIPTION OF THE DRAWINGS

FIG. 1 is a perspective view of a typical saw on which the laser guide of the invention is used.

FIG. 2 is a side view of the mounting arrangement of a cutting wheel or saw blade on a first type of saw arbor.

FIG. 3 is a side view of the mounting arrangement of a cutting wheel or saw blade on a second type of saw arbor.

FIG. 4 is a side view of the mounting arrangement of the laser guide and cutting wheel or saw blade on the first type of saw arbor.

FIG. 5 is a side view of the mounting arrangement of the laser guide and cutting wheel or saw blade on the second type of saw arbor.

FIG. 6 is a plan view of an embodiment of the laser guide of the invention

FIG. 7 is a plan view of an embodiment of the laser guide of the invention with the adapter insert removed from the housing.

FIG. 8 is a plan view of an embodiment of the laser guide of the invention with the cover removed from the housing.

FIG. 9 is a back view of an embodiment of the housing cover.

FIG. 10 is a side view of an embodiment of the laser guide of the invention.

FIG. 11 is a section view taken along line 11-11 of FIG. 6.

FIG. 12 is an exploded perspective view of an alternate embodiment of the laser guide of the invention.

### DETAILED DESCRIPTION OF EMBODIMENTS OF THE INVENTION

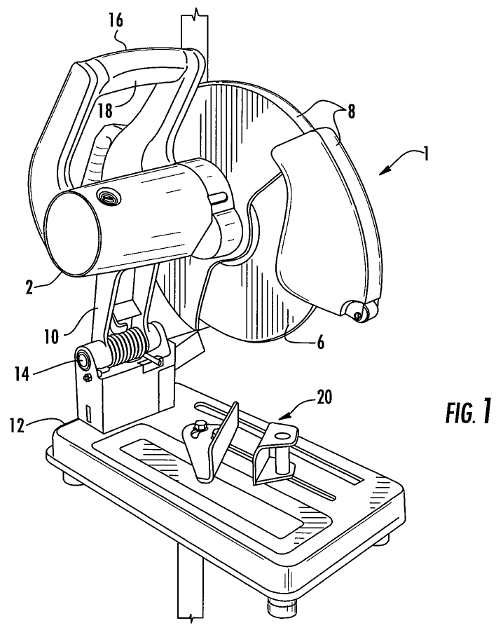

Referring to FIG. 1 a typical rotary power saw is shown at 1 consisting of a motor housing 2 that supports a motor for rotating an arbor or spindle shaft (hereinafter “arbor”). The arbor supports a cutting wheel 6 for rotation therewith. While a cutting wheel is illustrated it is to be understood that a saw blade may also be used. Guards 8 cover a portion of the cutting wheel or blade 6. Typically the motor and motor housing 2 are supported on an arm 10 that is pivotably connected to base 12 at pivot 14. A handle 16 is provided with a trigger 18 for pivoting the housing 2 and cutting wheel or blade 6 toward and away from base 12. Depressing trigger 18 causes the arbor and cutting wheel or blade to rotate. A clamp 20 may be provided for retaining the work piece on the base 12.

FIGS. 2 and 3 show two different types of mounting arrangements for the cutting wheel or blade. Referring to FIG. 2, to retain the cutting wheel or blade 6 on the arbor 4 an inside flange 22 is located on the arbor generally adjacent to the motor housing 2. The central arbor hole of the wheel or blade 6 is placed on the arbor 4 such that the first side of the wheel or blade abuts the inside flange 22. An outside flange 23 is disposed on the arbor 4 abutting the opposite side of the wheel or blade 6 from inside flange 22. A flat washer 24 may be placed on the arbor 4 and abutting the outside flange 23. Finally, a fastening member 26 is tightened on the arbor 4 to compress these elements together to retain the wheel or blade 6 on the arbor. While in the illustrated device a bolt is illustrated as the fastening member 26 that engages an internally threaded portion 28 of the arbor 4, a threaded nut may be used in place of the bolt that engages an externally threaded member on the arbor. In either case the force generated as the fastening member 26 is tightened is transferred to the cutting wheel or blade 6 over the relatively large area of the inside flange 22 and the outside flange 23. Moreover the outside flange 23 is designed to generally conform to the size and shape of the inside flange 22 such that the forces generated by the inside flange 22 on one side of the cutting wheel or blade 6 are opposed by the substantially coextensive outside flange 23 disposed on the opposite side of the cutting wheel or blade 6.

Referring to FIG. 3, a second mounting arrangement is shown where the arbor 30 includes a first portion 30a having a first diameter that is intended to receive the central arbor hole of the inside flange 22 and the cutting wheel or blade 6. The arbor 30 further includes a second portion 30b that has a smaller diameter than the first portion 30a that is adapted to receive the arbor hole of the outside flange 32. In one embodiment first portion 30a has a diameter of one inch and second portion 30b has a diameter of 17 millimeters or ⅝ inch. To retain the cutting wheel or blade 6 on the arbor 30 inside flange 22 is located on the arbor first portion 30a generally adjacent to the motor housing 2. The wheel or blade 6 is placed on the arbor first portion 30a with its first side abutting the inside flange 22. An outside flange 36 is disposed on the arbor second portion 30b abutting the opposite side of the wheel or blade 6 from inside flange 22. A flat washer 38 may be placed on the arbor and abutting the outside flange 36. Finally, a fastening member 40 is tightened on the arbor 30 to compress these elements together to retain the wheel or blade 6 on the arbor. While in the illustrated device a bolt is illustrated as the fastening member 40 that engages an internally threaded portion 42 of the arbor 30, a threaded nut may be used in place of the bolt that engages an externally threaded member on the arbor. In either case the force generated as the fastening member 40 is tightened is transferred to the cutting wheel or blade 6 over the relatively large area of the inside flange 22 and the outside flange 36. Moreover the outside flange 36 is designed to generally conform to the size and shape of the inside flange 22 such that the forces generated by the inside flange 22 on one side of the cutting wheel or blade 6 are opposed by the substantially coextensive outside flange 36 disposed on the opposite side of the cutting wheel or blade 6.

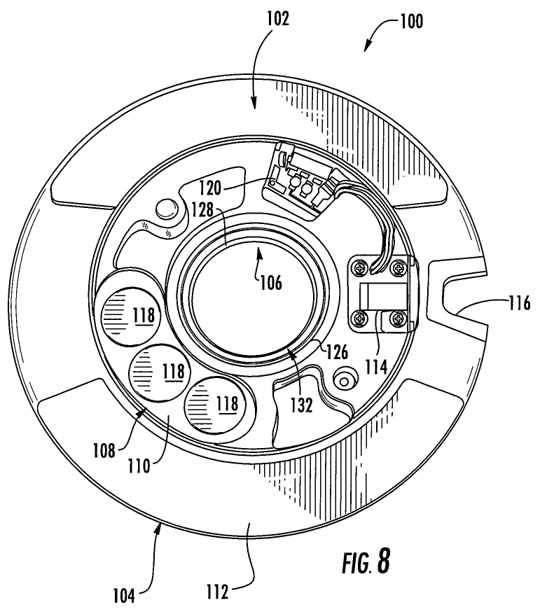

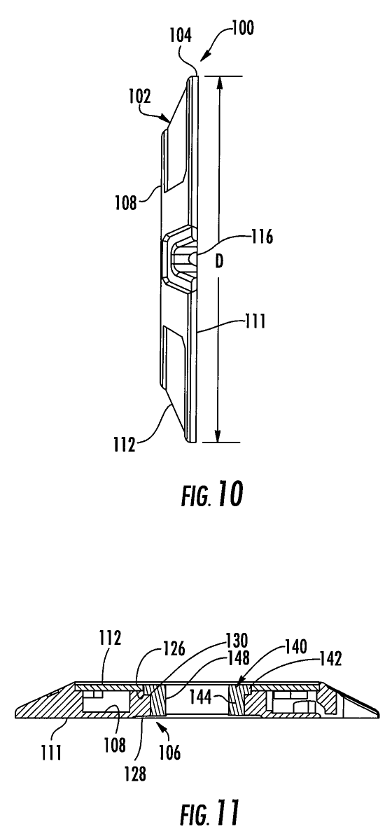

One embodiment of the laser guide 100 of the invention is illustrated in FIGS. 6 through 11 and comprises a housing 102 having a generally circular outer periphery 104. A centrally located aperture 106 is formed in the housing 102 such that housing 102 has a generally annular shape. Housing 102 has an interior portion 108 that defines a chamber 110 for retaining the laser guide components surrounded by a tapered flange portion 112 that becomes thinner in the direction away from interior portion 108.

Tapered flange 112 is dimensioned such that the housing has an external dimension D of between 3 and 4 inches. In a preferred embodiment the outer dimension is at least 3.5 inches with a preferred dimension of 3.9 inches. In one embodiment the outer dimension is selected to substantially match the outer dimension of the interior flange 22 such that the forces generated by the inside flange are opposed by the laser guide to prevent deformation of the cutting wheel or blade.

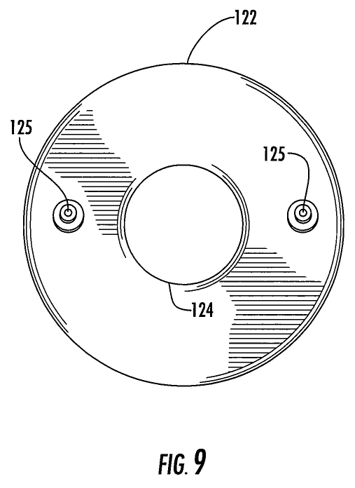

Referring to FIG. 8, located within chamber 110 is a laser 114. The light beam generated by laser 114 is directed into a prism which reflects and translates the beam of light adjacent to the mounting surface 111 (the surface adjacent the wheel or blade 6) and out of the housing section 102 at opening 116. Batteries 118 may be provided for powering the laser 114. An on/off switch 120 such as a centrifugal switch is provided for turning the laser on and off.

A housing cover 122 is secured by screws positioned on the bottom of the laser guide to isolate the laser components from the external environment. Cover 122 includes a centrally located aperture 124 that is coextensive with aperture 106. Cover 122 may be releasably secured to the housing 102 by screws 125 or other fastener such that the components are accessible for manufacture and repair and replacement.

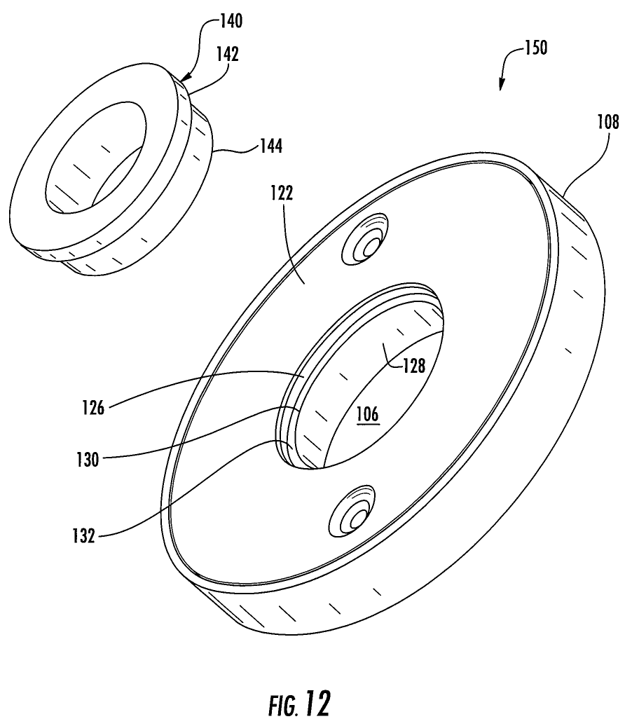

Referring to FIG. 11, aperture 106 has a counterbore configuration where an outer bore 126 having a first diameter is coaxially located with an inner bore 128 having a second smaller diameter at stepped portion 130 to create a bearing surface 132 for supporting a knockdown insert 140. Knockdown insert 140 comprises an annular ring having a first section 142, the outer diameter of which is closely received in the outer bore 126 and a second section 144 the outer diameter of which is closely received in inner bore 128 such that surface 146 bears against surface 132. In the illustrated embodiment the insert 140 is slid into aperture 106. In an alternate embodiment the interior wall of inner bore 128 and the exterior wall of second section 144 may be threaded such that the insert 140 may be screwed into the aperture 106. Other connecting mechanisms such as a snap fit connection or spring loaded ball and detent may also be used to secure the insert 140 in aperture 106. The circumference of the interior aperture 148 of insert 140 is less than the interior circumference of aperture 124. Thus, with insert 140 located in aperture 106 of the housing 102, the laser guide 100 may be mounted on a first size arbor and with the insert 140 removed from aperture 106 the laser guide may be mounted on a different size arbor. In one embodiment aperture 106 is dimensioned to fit one inch diameter arbors and aperture 148 is dimensioned to fit ⅝ inch or 17 millimeter diameter arbors. It will be appreciated that other inserts may also be provided having internal apertures that are dimensioned to fit other size arbors such that the laser guide may be sold as a kit with one or more inserts such that a variety of saw arbor sizes may be accommodated using the same laser guide.

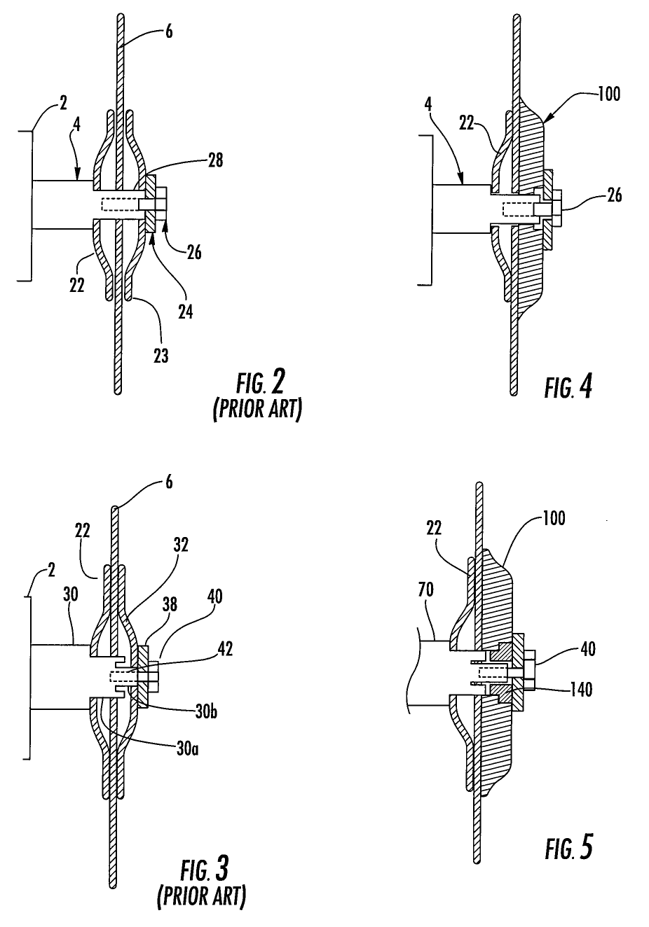

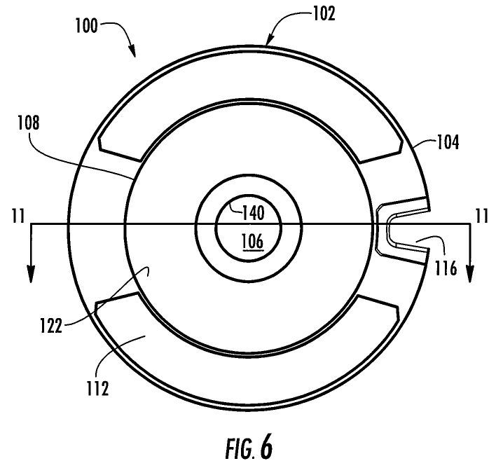

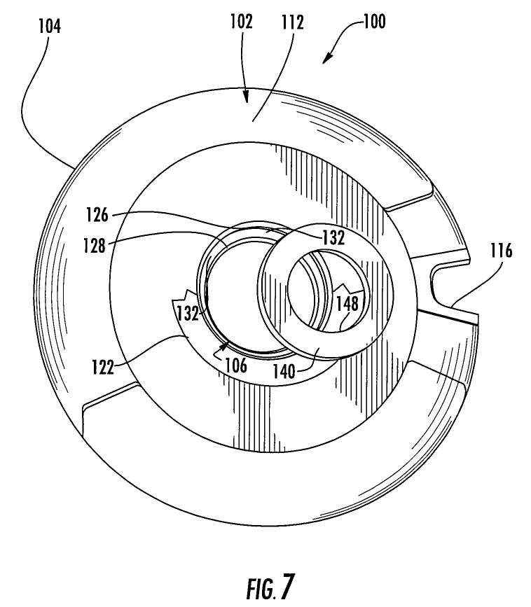

Referring to FIGS. 4 and 5 the laser guide of the invention is shown mounted on two different types and sizes of arbors. In FIG. 4 the laser guide 100 is mounted on an arbor with the insert removed such that the arbor is mounted directly in counterbore 106. In FIG. 5 the laser guide 100 is mounted on a second type of arbor where the arbor portion for receiving the laser guide has a smaller diameter. In this mounting arrangement the insert 140 is located in counterbore 106 such that the insert is disposed between the arbor and the laser guide housing. In either arrangement the laser guide of the invention 100 is disposed on the arbor abutting the opposite side of the wheel or blade 6 from inside flange 22. In either case the force generated as the fastening member 26 or 40 is tightened is transferred to the cutting wheel or blade 6 over the relatively large area of the inside flange 22 and laser guide 100. Moreover the laser guide 100 is designed to generally conform to the size and shape of the inside flange 22 such that the forces generated by the flange 22 on one side of the cutting wheel or blade 6 are opposed by the substantially coextensive laser guide 100 disposed on the opposite side of the cutting wheel or blade 6.

Referring to FIG. 12 an alternate embodiment of the laser guide of the invention is shown where like reference numerals are used to identify like components previously described with reference to the embodiment shown in FIGS. 6 through 11. The laser guide of FIG. 12 is essentially the same as that shown in FIGS. 3 through 6 except that housing 150 does not include the flange 112.

Specific embodiments of an invention are described herein. One of ordinary skill in the art will recognize that the invention has other applications in other environments. In fact, many embodiments and implementations are possible. The following claims are in no way intended to limit the scope of the invention to the specific embodiments described above.

1. A laser guide for saws having arbors comprising:
a housing defining an internal aperture having a first dimension;
an insert removably located in said internal aperture defining a second aperture having a second dimension;
whereby the laser guide may be mounted on different size arbors.

2. The laser guide of claim 1 where the first aperture accommodates a one inch arbor.

3. The laser guide of claim 1 where the second aperture accommodates a ⅝ inch arbor.

4. The laser guide of claim 1 where the first aperture includes a bearing surface against which the insert abuts.

5. The laser guide of claim 1 wherein the housing includes an integrally formed flange.

6. The laser guide of claim 1 wherein the housing includes a flange having dimensioned to oppose the forces generated by an interior flange mounted on the arbor.

7. The laser guide of claim 1 wherein the housing is approximately 3.5 to 4 inches in width.

8. The laser guide of claim 1 wherein the housing is approximately 3.9 inches in diameter.

9. The laser guide of claim 1 wherein the housing is at least approximately 3.5 inches in diameter.

10. The laser guide of claim 1 wherein said first aperture is formed as a counterbore.

11. The laser guide of claim 1 wherein said housing includes a laser generator.

12. The laser guide of claim 5 wherein the flange is tapered.

13. A laser guide for saws having arbors comprising:
a housing defining an internal aperture having a first dimension and an integrally formed flange, said flange dimensioned to oppose the forces generated by an interior flange mounted on the arbor; and
an insert removably located in said internal aperture defining a second aperture having a second dimension;
whereby the laser guide may be mounted on different size arbors.

14. The laser guide of claim 13 wherein the housing is approximately 3.9 inches in width.

15. The laser guide of claim 13 wherein the housing is between 3.5 and 4.0 inches in diameter.

16. A laser guide kit comprising:
a housing defining an internal aperture having a first dimension;
at least one insert adapted to be located in said internal aperture and defining a second aperture having a second dimension;
whereby the laser guide may be mounted on different size arbors.

17. A method of using a laser guide for saws having arbors comprising:
providing a housing defining an internal aperture having a first dimension;
providing an insert adapted to be removably located in said internal aperture and defining a second aperture having a second dimension;
selectively locating the insert in the internal aperture to size the laser guide for mounting on a correspondingly sized arbor.

18. A laser guide for saws having arbors comprising:
a housing defining an internal aperture having a first dimension and an integrally formed flange, said flange dimensioned to oppose the forces generated by an interior flange mounted on the arbor.

19. The laser guide of claim 18 wherein the housing is approximately 3.9 inches in width.

20. The laser guide of claim 18 wherein the housing is between 3.5 and 4.0 inches in diameter.
